(19) United States
(12) Patent Application Publication
(10) Pub. No.: US 2021/0370478 A1
(43) Pub. Date: Dec. 2, 2021

(54) Pliers

(71) Applicant: Wu-Lang Lin, Taichung (TW)

(72) Inventor: Wu-Lang Lin, Taichung (TW)

(21) Appl. No.: 16/888,980

(22) Filed: Jun. 1, 2020

(51) Int. Cl. B25B 7/08

(52) U.S. Cl. CPC B25B 7/08

(57) ABSTRACT

A pliers includes two main bodies pivotally coupled to one another. A first main body defines a first pivot hole and a second main body defines a second pivot hole respectively. The first pivot hole has a first inner peripheral section with a flaring conical shape. Furthermore, the first pivot hole has a second inner peripheral section with a flaring conical shape. The first inner peripheral section has a first cone angle and the second inner peripheral section has a second cone angle respectively. The second cone angle is smaller than the first cone angle. The first and the second main bodies are pivotally interconnected with a fastener. The fastener has a first outer peripheral section abutting and conforming to the first inner peripheral section and a second outer peripheral section abutting and conforming to the second inner peripheral section respectively.

### BACKGROUND OF THE INVENTION

### 1. Field of the Invention

The present invention relates to pliers and, particularly, to a stout pliers.

### 2. Description of the Related Art

TW Pat. No. 1580533 shows a pliers with a first main body and a second main body. The first main body forms a first working end and a first grasping end of the pliers. The second main body forms a second working end and a second grasping end of the pliers. The second main body is opposite to the first main body. The first and the second main bodies are pivotally interconnected by a fastening device. The fastening device includes a pivotal fastener inserting through the first and the second bodies as well as a retainer securing the fastener to the first and the second bodies. The first and the second main bodies cooperate to receive a joint flange, and fastening device is surrounded by the joint flange.

It is noted that the first and the second main bodies, as they pivot relative to one another, will gradually abrade the fastener, the retainer, and the joint flange. Consequently, gaps are created between the first and the second main bodies have gaps created between, which make the first and the second main bodies shake inadequately and the pliers cannot hold an object stably.

The present invention is, therefore, intended to obviate or at least alleviate the problems encountered in the prior art.

### SUMMARY OF THE INVENTION

According to the present invention, a pliers includes two main bodies pivotally coupled to one another. A first main body has a first side and a second side opposite to the first side and defines a first pivot hole extending through the first and the second sides. The first pivot hole has a first inner peripheral section with a flaring conical shape which has an increased radius from an end adjacent to the first side. Furthermore, the first pivot hole has a second inner peripheral section with a flaring conical shape which has an increased radius from an end adjacent to the first inner peripheral section to an end adjacent to the second side.

The first inner peripheral section has a first cone angle and the second inner peripheral section has a second cone angle respectively. The second cone angle is smaller than the first cone angle.

A second main body defines a second pivot hole. The first and the second main bodies are pivotally interconnected with a fastener. The fastener is engaged in the first and the second pivot holes. The fastener has a first outer peripheral section abutting and conforming to the first inner peripheral section. Furthermore, the fastener has a second outer peripheral section abutting and conforming to the second inner peripheral section.

According to another preferred embodiment of this invention, a quick-turning wrench includes a driving end with a first jaw and a second jaw. The first and the second jaws respectively have a first and a second side, which face one another. The driving end defines an engaging space between the first and the second jaws. The driving end has a first grip-surface section, a second grip-surface section, a third grip-surface section, and a fourth grip-surface section configured for gripping the object to be driven by the quick-turning wrench. The engaging space is partially delimited by the first, the second, the third, and the fourth grip-surface sections. The first and the second grip-surface sections are adjacent to the first side and respectively extend along a flat first phantom surface and a flat second phantom surface. The third and the fourth grip-surface sections are adjacent to the second side and respectively extend along a flat third phantom surface and a flat fourth phantom surface. The first phantom surface and the second phantom surface intersect with one another and have a first angle defined therebetween greater than 100 degrees and less than 150 degrees. The third phantom surface and the fourth phantom surface intersect with one another and have a second angle defined therebetween greater than 100 degrees and less than 150 degrees.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a pliers in accordance with the present invention.

FIG. 2 is an exploded perspective view of the pliers of FIG. 1.

FIG. 3 is a cross-sectional view of a working end of the pliers of FIG. 1.

### DETAILED DESCRIPTION OF THE INVENTION

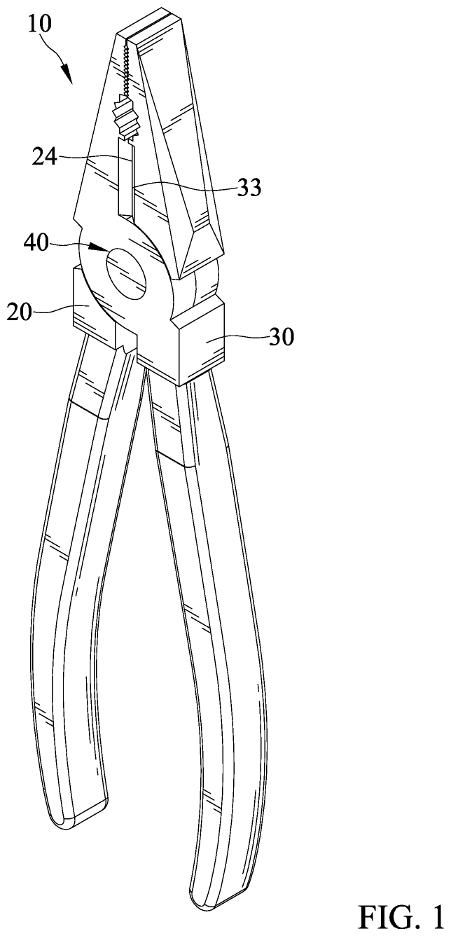

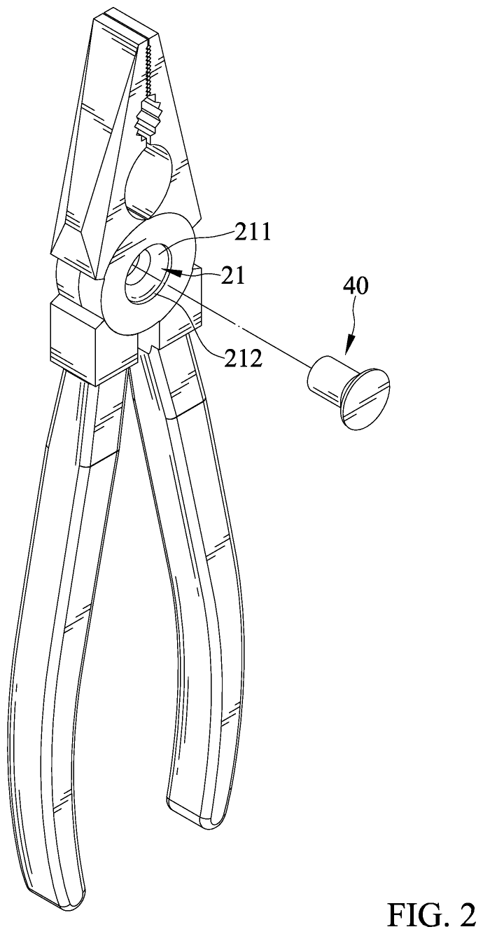

FIGS. 1 through 3 show a pliers 10 in accordance with the present invention. The pliers 10 includes two main bodies 20 and 30 pivotally coupled to one another with a fastener 40. The main bodies 20 and 30 are pivotal about an axis L which extends along the longitudinal length of the fastener 40. Furthermore, the axis L extends along the center of the fastener 40.

The main body 20 has a side 22 and a side 23 opposite to the side 22. The main body 20 defines a pivot hole 21 extending through the sides 22 and 23. The pivot hole 21 has an inner peripheral section 211 with a flaring conical shape which has an increased radius from an end adjacent to the side 22. Furthermore, the pivot hole 21 has an inner peripheral section 212 with a flaring conical shape which has an increased radius from an end adjacent to the inner peripheral section 211 to an end adjacent to the side 23.

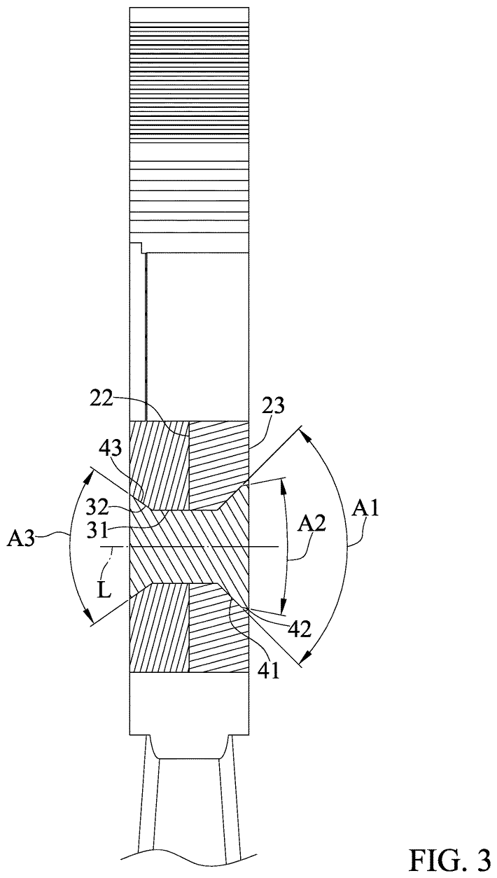

The inner peripheral section 211 has a cone angle A1 and the inner peripheral section 212 has a cone angle A2 respectively. The cone angle A2 is smaller than the cone angle A1. As shown in FIG. 3, the inner peripheral section 211 has two inclined divergent edges that are angled with one another with the cone angle A1, and the inner peripheral section 212 has two inclined divergent edges that are angled with one another with the cone angle A2. The cone angle A1 is greater than 80 degrees and less than 100 degrees. The cone angle A2 is greater than 10 degrees and less than 40 degrees. Preferably, the cone angle A1 is 90 degrees. Preferably, the cone angle A2 is 22 degrees.

The main body 30 defining a pivot hole 31. The pivot hole 31 extends through the main body 30. The pivot hole 31 has an inner peripheral section 32 with a flaring conical shape which has an increased radius as extending away from the main body 20. The fastener 40 has an outer peripheral section 43 abutting and conforming to the inner peripheral section 32. The inner peripheral section 32 has a cone angle A3 which equals to 90 degrees.

The main bodies 20 and 30 are pivotally interconnected with the fastener 40. The fastener 40 is engaged in the pivot holes 21 and 31. The fastener 40 has an outer peripheral section 41 abutting and conforming to the inner peripheral section 211. The inner peripheral section 211 and the outer peripheral section 41 are in surface-to-surface contact. Furthermore, the fastener 40 has an outer peripheral section 42 abutting and conforming to the inner peripheral section 211. The inner peripheral section 212 and the outer peripheral section 42 are in surface-to-surface contact. Moreover, the fastener 40 is partially engaged in a section of the pivot hole 21 which has a uniform radius and partially engaged in a section of the pivot hole 31 which has a uniform radius. The fastener 40 is riveted in the pivot holes 21 and 31. The fastener 40 includes the outer peripheral sections 42 and 43 at two distal ends respectively.

The main bodies 20 and 30 have corresponding ends forming working ends and the working ends of the main bodies 20 and 30 are configured to cooperatively hold an object to be acted by the pliers 10. The working ends of the main bodies 20 and 30 have corresponding cutting blade portions 24 and 33 adapted to be used to strip wires.

In view of the foregoing, in order to make the pliers 10 have a long use life, the shapes of the pivot hole 21 is designed with flaring inner peripheral sections 211 and 212 and the fastener 40 includes conforming flaring outer peripheral sections 41 and 42 abutting the inner peripheral sections 211 and 212 respectively.

Furthermore, the pivot hole 31 is designed with flaring inner peripheral section 32 and the fastener includes conforming flaring outer peripheral section 43 abutting the inner peripheral section 32.

Moreover, the fastener 40 is riveted in the pivot holes 21 and 31.

The foregoing is merely illustrative of the principles of this invention and various modifications can be made by those skilled in the art without departing from the scope and spirit of the invention.

What is claimed is:

1. A pliers comprising:
a first main body having a first side and a second side opposite to the first side and defining a first pivot hole extending through the first and the second sides, wherein the first pivot hole has a first inner peripheral section with a flaring conical shape which has an increased radius from an end adjacent to the first side, wherein the first pivot hole has a second inner peripheral section with a flaring conical shape which has an increased radius from an end adjacent to the first inner peripheral section to an end adjacent to the second side, wherein the first inner peripheral section has a first cone angle and the second inner peripheral section has a second cone angle respectively, and wherein the second cone angle is smaller than the first cone angle;
a second main body defining a second pivot hole; and
a fastener, wherein the first and the second main bodies are pivotally interconnected with the fastener, wherein the fastener is engaged in the first and the second pivot holes, wherein the fastener has a first outer peripheral section abutting and conforming to the first inner peripheral section, and wherein the fastener has a second outer peripheral section abutting and conforming to the second inner peripheral section.

2. The pliers as claimed in claim 1, wherein the first cone angle is greater than 80 degrees and less than 100 degrees, and wherein the second cone angle is greater than 10 degrees and less than 40 degrees.

3. The pliers as claimed in claim 1, wherein the first cone angle is 90 degrees, and wherein the second cone angle is 22 degrees.

4. The pliers as claimed in claim 1, wherein the second pivot hole has a third inner peripheral section with a flaring conical shape which has an increased radius as extending away from the first main body, and wherein the fastener has a third outer peripheral section abutting and conforming to the third inner peripheral section.

5. The pliers as claimed in claim 4, wherein the third inner peripheral section has a third cone angle which equals to 90 degrees.

6. The pliers as claimed in claim 1, wherein the first and the second main bodies have corresponding ends forming working ends and the working ends of the first and the second main bodies are configured to cooperatively hold an object to be acted by the pliers, and wherein the working ends of the first and the second main bodies have corresponding cutting blade portions adapted to be used to strip wires.

7. The pliers as claimed in claim 1, wherein the fastener is riveted in the first and the second pivot holes.

8. The pliers as claimed in claim 1, wherein the second pivot hole extends through the second main body.

9. The pliers as claimed in claim 4, wherein the fastener is riveted in the first and the second pivot holes.

10. The pliers as claimed in claim 4, wherein the first and the second main bodies have corresponding ends forming working ends and the working ends of the first and the second main bodies are configured to cooperatively hold an object to be acted by the pliers, and wherein the working ends of the first and the second main bodies having corresponding cutting blade portions adapted to be used to strip wires.

11. The pliers as claimed in claim 1, wherein the fastener is partially engaged in a section of the first pivot hole which has a uniform radius and partially engaged in a section of the second pivot hole which has a uniform radius.

12. The pliers as claimed in claim 4, wherein the fastener is partially engaged in a section of the first pivot hole which has a uniform radius and partially engaged in a section of the second pivot hole which has a uniform radius.

13. The pliers as claimed in claim 12, wherein the fastener includes the second and the third outer peripheral sections at two distal ends respectively.
